(19) United States
(12) Patent Application Publication
(10) Pub. No.: US 2003/0050381 A1
(43) Pub. Date: Mar. 13, 2003

(54) Dispersion of pigments in polypropylene

(76) Inventors: Gerd Hohner, Gersthofen (DE); Rainer Bott, Gross-Gerau (DE); Reiner Hess, Gersthofen (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/220,076

(22) PCT Filed: Feb. 15, 2001
(86) PCT No.: PCT/EP01/01669

(30) Foreign Application Priority Data
Mar. 1, 2000 (DE) 10009751.0
Dec. 20, 2000 (DE) 10063421.4

(51) Int. Cl. C08K 5/01

(52) U.S. Cl. 524/487

(57) ABSTRACT

The invention relates to the use of polyolefin waxes, which are produced by means of metallocene catalysis, for improving the dispersion of pigments in polypropylene.

The present invention relates to a process for the improved preparation of a colorant composed of at least one chromophore which is dispersed very finely in a meltable base material (matrix) which is solid at room temperature and also to the use of polyolefin waxes prepared with the aid of metallocene catalysts for improving the dispersing of the colorant in a polypropylene matrix, particularly for producing polypropylene fiber.

Pigment preparations which can be used for coloring polyolefins are known:

DE-B-1 239 093 describes a carrier material for producing a pigment preparation which is composed of a mixture of an amorphous ethylene-polypropylene block copolymer with a viscosity of from 5000 to 300,000 cps at 150° C. and a low molecular mass crystalline polypropylene.

DE-A-26 52 628 describes the use of a low molecular mass polypropylene wax with a viscosity of from 500 to 5000 cP at 170° C. as a dispersing aid.

DE-C-42 36 337 describes the use of polyacrylate esters as dispersing aids for pigments in polymer matrices.

U.S. Pat. No. 5,880,193 describes the use of an amorphous poly-α-olefin (0-90%) which is used in a mixture with a polyolefin wax (0-90%) and a special polyacrylate (0-50%).

All of the substances or mixtures listed above have the disadvantage of inadequate wetting, especially of organic pigments that are difficult to disperse, such as those of the quinacridone group or phthalocyanines, which as a result are dispersed in the polypropylene matrix with inadequate fineness, leading, especially in the case of the subsequent production of polypropylene fiber, to broken ends as a result of coarse pigment particles.

The object was therefore to provide a dispersing aid for pigments in polypropylene which results in adequate dispersion of the polymer particles so that there are fewer broken ends during fiber production.

It has surprisingly been found that polyolefin waxes prepared by metallocene catalysis ensure very effective dispersing pigments in polypropylene.

The invention provides for the use of polyolefin waxes prepared by means of metallocene catalysts as dispersing aids for pigments in polypropylene.

The invention further provides a process for preparing a masterbatch by blending a polymer with a colorant, which comprises admixing at least one polyolefin wax obtained by metallocene catalysis.

The pigments are preferably organic pigments.

Suitable polyolefin waxes include homopolymers of ethylene or of propylene or copolymers of the two olefins or copolymers of ethylene or of propylene with one or more further olefins. Further olefins used are linear or branched olefins having 4-18 carbon atoms, preferably 4-6 carbon atoms. Examples thereof are 1-butene, 1-hexene, 1-octene or 1-octadecene, and also styrene. The copolymers are composed of 70-99.9%, preferably 80-99%, by weight of ethylene or propylene. Preference is given to homopolymers of ethylene or propylene and also to copolymers of ethylene and propylene.

Particularly suitable polyolefin waxes are those having a dropping point of between 90 and 165° C., preferably between 100 and 160° C., a melt viscosity at 170° C. of between 5 and 10,000 mPa·s, preferably between 10 and 5000 mPa·s, and a density at 20° C. at between 0.86 and 0.98 g/cm³, preferably between 0.87 and 0.96 g/cm³.

The waxes can be used either per se or else in polar-modified form. Conventional possibilities for the modification include, for example, oxidation with air or graft polymerization with polar monomers, an example being maleic anhydride.

In preferred embodiments of the invention the metallocene waxes used in accordance with the invention are used in a blend with auxiliaries and additives which enhance the dispersing action of the metallocene waxes. Examples of such auxiliaries and additives include

a) polyethylene glycol,

b) PE waxes,

c) PTFE waxes,

d) PP waxes,

e) amide waxes,

f) FT paraffins,

g) montan waxes,

h) natural waxes,

i) macro- and microcrystalline paraffins,

j) polar polyolefin waxes, or

k) sorbitan esters,

l) polyamides,

m) polyolefins,

n) PTFE,

o) wetting agents,

p) silicates.

Additive a) comprises polyethylene glycol, molecular weight range preferably from 10 to 50,000 daltons, in particular from 20 to 35,000 daltons. The polyethylene glycol can be admixed to the metallocene wax composition in amounts of preferably up to 5% by weight.

Additive b) comprises in preferred embodiments polyethylene homopolymer and copolymer waxes not prepared by means of metallocene catalysis, having a number-average molecular weight of from 700 to 10,000 g/mol with a dropping point between 80 and 140° C.

Additive c) comprises in preferred embodiments polytetrafluoroethylene having a molecular weight of between 30,000 and 2,000,000 g/mol, in particular between 100,000 and 1,000,000 g/mol.

Additive d) comprises in preferred embodiments polypropylene homopolymer and copolymer waxes not prepared by means of metallocene catalysis, having a number-average molecular weight of from 700 to 10,000 g/mol with a dropping point between 80 and 160° C.

Additive e) comprises in preferred embodiments amide waxes preparable by reacting ammonia or ethylenediamine with saturated and/or unsaturated fatty acids. The fatty acids comprise, for example, stearic acid, tallow fatty acid, palmitic acid or erucic acid.

Additive f) comprises in preferred embodiments FT paraffins having a number-average molecular weight of from 400 to 800 g/mol with a dropping point of from 80 to 125° C.

Additive g) preferably comprises montan waxes, including acid waxes and ester waxes having a carboxylic acid carbon chain length of from C₂₂ to C₃₆.

The ester waxes preferably comprise reaction products of the montanic acids with monohydric or polyhydric alcohols having from 2 to 6 carbon atoms, such as ethanediol, butane-1,3-diol or propane-1,2,3-triol, for example.

Additive h) comprises in one preferred embodiment carnauba wax or candelilla wax.

Additive i) comprises paraffins and microcrystalline waxes obtained in the course of petroleum refining. The dropping points of such paraffins are preferably between 45 and 65° C., those of microcrystalline waxes of this kind preferably between 73 and 100° C.

Additive j) comprises in preferred embodiments polar polyolefin waxes preparable by oxidizing ethylene or propylene homopolymer and copolymer waxes or by grafting them with maleic anhydride. A particularly preferred starting point for these waxes are polyolefin waxes having a dropping point of between 90 and 165° C., in particular between 100 and 160° C., a melt viscosity at 140° C. (polyethylene waxes) or at 170° C. (polypropylene waxes) of between 10 and 10,000 mPas, in particular between 50 and 5000 mPas, and a density at 20° C. of between 0.85 and 0.96 g/cm³.

Additive k) comprises in preferred embodiments reaction products of sorbitol with saturated and/or unsaturated fatty acids and/or montanic acids. The fatty acids comprise, for example, stearic acid, tallow fatty acid, palmitic acid or erucic acid.

Additive l) comprises preferably ground polyamides, examples including polyamide-6, polyamide-6,6 or polyamide-12. The particle size of the polyamides is preferably in the range of 5-200 μm, in particular 10-100 μm.

Additive m) comprises polyolefins, i.e., for example, polypropylene, polyethylene or copolymers of propylene and ethylene of high or low density having molar weights of preferably from 10,000 to 1,000,000 D, in particular from 15,000 to 500,000 D, as the numerical average of the molecular weight, whose particle size is situated, as a result of grinding, in the range of preferably 5-200 μm, in particular 10-100 μm.

Additive n) comprises thermoplastic PTFE having a molar weight of preferably 500,000-10,000,000 D, especially 500,000-2,000,000 D, as the numerical average, whose particle size is situated, as a result of grinding, in the range of preferably 5-200 μm, especially 10-100 μm.

Additive o) comprises amphiphilic compounds which generally lower the surface tension of liquids. The wetting agents comprise, for example, alkyl ethoxylates, fatty alcohol ethoxylates, alkylbenzenesulfonates or betaines.

Additive p) comprises silicates which are not used as a filler or pigment in the formulations. Preference is given to using silicas or talc.

The mixing ratio of constituent a) to the constituents b) to p) can be varied in the range from 1 to 99% by weight a) to 1 to 99% by weight b) to p). Where a mixture of two or more of the constituents b) to p) is used, the amount indicated applies to the sum of the amounts of these constituents.

In one preferred embodiment the waxes are used in micronized form for the purpose according to the invention. Particular preference is given to the use of polyolefin wax and, where appropriate, admixed auxiliaries and additives as an ultrafine powder having a particle size distribution d₉₀<40 μm.

Particular preference is given to the inventive use of polyolefin waxes for producing colorant concentrates for (LD) polyethylene films.

Metallocene catalysts for preparing the polyolefin waxes are chiral or nonchiral transition metal compounds of the formula M¹Lₓ. The transition metal compound M¹Lₓ contains at least one central metal atom M¹ attached to which there is at least one Π ligand, e.g. a cyclopentadienyl ligand. Substituents as well, such as halogen, alkyl, alkoxy or aryl groups, for example, may be attached to the central metal atom M¹. M¹ is preferably an element from main group III, IV, V or VI of the Periodic Table of the Elements, such as Ti, Zr or Hf. By cyclopentadienyl ligand are meant unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The Π ligands may be bridged or unbridged, with single and multiple bridging—including that via ring systems—being possible. The term “metallocene” also embraces compounds containing more than one metallocene fragment, known as polynuclear metallocenes. These may feature arbitrary substitution patterns and bridging variants. The individual metallocene fragments of such polynuclear metallocenes may be either identical to or different from one another. Examples of such polynuclear metallocenes are described, for example, in EP-A-632 063.

Examples of general structural formulae of metallocenes and also of their activation with a cocatalyst are given, inter alia, in EP-A-571 882.

The invention is illustrated by the following examples.

### EXAMPLES

The melt viscosities of the waxes used below were determined with a rotational viscometer in accordance with DGF-M-III 8 (57), the dropping points in accordance with DGF-M-III 3 (75) (standards of the Deutschen Gesellschaft für Fettwissenschaft), the densities in accordance with DIN 53479.

For defining the quality of the dispersing of a pigment in the polyolefin matrix use is made below of the filter index, which is defined as follows:

D_{F}=(Pₘₐₓ-P₀)/m_{pigment}

The filter index according to this definition, therefore, is the extent of the pressure increase due to filtering a defined amount of dispersed pigment, i.e., the measure of the “blocking” of the filter by undispersed or poorly dispersed pigment, relative to the amount of pigment used.

In preparing the pigment masterbatches of the examples a Henschel FM 10 mixer is used which typically ensures statistical distribution of the starting components at from 600 to 1500 revolutions/min for from 4 to 10 minutes (at room temperature). Actual dispersing (typically in an iPP matrix) takes place in a corotating twin-screw extruder with a screw length of from 30 to 48 D, which operates with a temperature profile of from 30 to 230° C. (feed→die). The rotary speed is between 100 to 550 revolutions/minute, operating with a throughput of from 4 to 30 kg/h. The table below illustrates the examples according to the inventive approach, and corresponding comparative examples according to the state of the art:

| | | | 3 | 4 | 5 |
|---|---|---|---|---|---|
| Constituent | 1 | 2 | (Comparative) | (Comparative) | (Comparative) |
| Polyolefin | 30% HBM | 30% HBM | Licowax ® | Epolene ® | Lionwachs ® |
| wax | 180 | 408/409 | PP 230 | E 43 | 530 |
| Type | Metallo- | Metallo- | Ziegler-PP | PP-MSA | PP- |
| | cene | cene | | | degraded |
| Pigment | 40% blue | 40% blue | 40% blue | 40% blue | 40% blue |
| | 15:1 | 15:1 | 15:1 | 15:1 | 15:1 |
| Polyolefin | 30% | 30% | 30% | 30% | 30% |
| | Borealis PP | Borealis PP | Borealis PP | Borealis PP | Borealis PP |
| | HG 235 J | HG 235 J | HG 235 J | HG 235 J | HG 235 J |
| Filter index | 14.8 | 12.0 | 17.0 | 19.8 | 17.6 |

1. The use of polyolefin waxes prepared by means of metallocene catalysts as dispersing aids for pigments in polypropylene.

2. The use as claimed in claim 1, wherein the polyolefin wax derives from olefins having 3 to 6 carbon atoms or from styrene.

3. The use as claimed in claim 1 and/or 2, wherein the polyolefin wax has a dropping point of from 90 to 130° C., a melt viscosity at 140° C. and from 10 to 10,000 mPa·s, and a density of from 0.89 to 0.98 g/cm³.

4. The use as claimed in one or more of claims 1 to 3, wherein the polyolefin waxes have been polar-modified.

5. The use as claimed in one or more of claims 1 to 4, wherein the polyolefin waxes are present in a blend with one or more auxiliaries and additives selected from the group consisting of
a) polyethylene glycol,
b) PE waxes,
c) PTFE waxes,
d) PP waxes,
e) amide waxes,
f) FT paraffins,
g) montan waxes,
h) natural waxes,
i) macro- and microcrystalline paraffins,
j) polar polyolefin waxes, or
k) sorbitan esters,
l) polyamides, very finely ground
m) polyolefins, very finely ground
n) PTFE, very finely ground
in a polyolefin wax:auxiliary and additive weight ratio of from 1:99 to 99:1.

6. The use as claimed in one or more of claims 1 to 5, wherein polyolefin wax and, where appropriate, the admixed auxiliaries and additives are present in the form of an ultrafine powder having a particle size distribution d₉₀<40 μm.

7. The use as claimed in one or more of claims 1 to 6, wherein the polypropylene comprises polypropylene fiber.

8. A process for preparing a masterbatch by blending a polymer with a colorant, which comprises admixing at least one polyolefin wax obtained by metallocene catalysis.
